(19) United States
(12) Patent Application Publication
(10) Pub. No.: US 2012/0136080 A1
(43) Pub. Date: May 31, 2012

(54) POROUS PARTICLES WITH IMPROVED FILTERING PERFORMANCE

(76) Inventors: Xiqiang Yang, Webster, NY (US); James R. Bennett, Rochester, NY (US)

(21) Appl. No.: 12/956,022

(22) Filed: Nov. 30, 2010

(51) Int. Cl. C08J 9/28; C08B 15/00; C08B 37/02; C08B 3/00

(52) U.S. Cl. 521/65; 536/63; 536/56; 536/112

(57) ABSTRACT

A method of manufacturing porous polymer particles with improved filterability is described. One or more first water phases are formed comprising an anionic hydrocolloid with a mass-per-charge value of less than 600 and a relatively minor amount, compared to the anionic hydrocolloid, of at least one of a nonionic, cationic, zwitterionic, or weakly anionic water soluble or dispersible polymer, where the weakly anionic water soluble or dispersible polymer has a mass-per-charge value of larger than 600. A water-in-oil emulsion is formed by dispersing the one or more first water phases into an organic phase comprising at least one of either (i) preformed polymer dissolved in an organic solvent or (ii) polymerizable monomers, and homogenizing. A water-in-oil-in-water multiple emulsion is formed by dispersing the water-in-oil emulsion into a second water phase containing a stabilizing agent and homogenizing. The organic solvent is removed to precipitate the preformed polymer, or the polymerizable monomers are polymerized, to obtain a dispersion of porous polymer particles in an external aqueous phase, wherein individual porous particles each comprise a continuous polymer phase and internal pores containing an internal aqueous phase. The dispersion of porous polymer particles is filtered to remove the external aqueous phase. The method enables increased filtration rates of porous polymer particle dispersions containing water in the pores.

### FIELD OF THE INVENTION

This invention relates to porous polymeric particles, wherein the porous particles have improved rate of filtration during washing and collection. Particularly the present invention relates to incorporating specific polymeric compounds in the pore stabilizing composition to facilitate the filtration of the porous particles.

### BACKGROUND OF THE INVENTION

Porous polymer particles are useful in numerous applications and many methods have been developed for their preparation. An evaporative limited coalescence (ELC) process involving multiple emulsions has been disclosed that provides a convenient and scalable manufacturing route to substantially monodisperse porous microparticles of preformed polymers. Particles thus prepared have been said to be useful as porous toner materials in electrophotographic (EP) printing, as disclosed in US Patent Application Publications US 2008/0176164 and US 2008/0176157, incorporated herein by reference for all that they contain.

In a common ELC process, polymer particles having a narrow size distribution may be obtained by forming a solution of a polymer in a solvent that is immiscible with water, dispersing, under suitable shear and mixing conditions, the solution so formed in an aqueous medium containing a solid colloidal stabilizer and removing the solvent. The resultant particles are then isolated, washed and dried.

In the practice of this technique, polymer particles may be prepared from any type of polymer that is soluble in a solvent that is immiscible with water. The size and size distribution of the resulting particles can be predetermined and controlled by the relative quantities of the particular polymer employed, the solvent, the quantity and size of the water insoluble solid particulate suspension stabilizer, typically silica or latex, and the size to which the solvent-polymer droplets are reduced by mechanical flowing and shearing using rotor-stator type colloid mills, high pressure homogenizers, agitation, etc.

Limited coalescence techniques of this type have been described in numerous patents pertaining to the preparation of electrostatographic toner particles because such techniques typically result in the formation of polymer particles having a substantially uniform size distribution. Representative limited coalescence processes employed in toner preparation are described in U.S. Pat. Nos. 4,833,060, 4,965,131, 6,544,705, 6,682,866, and 6,800,412; and US Patent Application No. 2004/0161687, incorporated herein by reference for all that they contain.

This technique for preparing toner samples generally includes the following steps: mixing a polymer material, a solvent and optionally additionally one or more of a colorant, a charge control agent, and a wax to form an organic phase; dispersing the organic phase in an aqueous phase comprising a particulate stabilizer and homogenizing the mixture; evaporating the solvent and washing and drying the resultant product.

Use of porous toner particles in an electrophotographic process can potentially reduce the toner mass in the image area. Simplistically, a toner particle with 50% porosity should require only half as much mass to accomplish the same imaging results. Hence, toner particles having an elevated porosity will lower the cost per page and decrease the stack height of the print as well. The application of porous toners provides a practical approach to reduce the cost of the print and improve the print quality.

U.S. Pat. Nos. 3,923,704; 4,339,237; 4,461,849; 4,489,174 and EP 0083188 discuss the preparation of multiple emulsions by mixing a first emulsion in a second aqueous phase to form polymer beads. These processes produce polymer particles having a large size distribution with little control over the porosity. This is not suitable for toner particles, or other particles requiring uniform size or porosity control.

US 2005/0026064 describes porous toner particles apparently obtained through a degassing reactive process. However control of particle size distribution along with the even distribution of pores throughout the particle is a problem.

US 2008/0176164 and US 2008/0176157 describe porous polymer particles useful as toner that are made by a limited coalescence/multiple emulsion process. This process involves the preparation of a first water-in-oil (W1/O) emulsion, where the W1 phase contains a water compatible pore stabilizing agent and the O phase is a polymer solution in a water immiscible solvent, followed by the dispersion of the W1/O emulsion into a second water phase (W2) that contains a particulate stabilizer and homogenization to form a water-in-oil-in-water or W1/O/W2 multiple emulsion. The organic solvent is then removed to obtain individual porous particles comprising a continuous polymer phase and internal pores containing an internal aqueous phase, where these individual particles are dispersed in an external aqueous phase. The particles are typically washed with water to remove stabilizers and salts from the external water phase, used in the preparation of the particles. The particles are typically isolated from the dispersion by a filtration process.

Ordinary filtration processes, either vacuum filtration or pressure filtration, for isolating porous particles comprising a continuous polymer phase and internal pores containing an internal aqueous phase from an external aqueous phase have been discovered to be generally very slow. US2010/0279225 describes techniques for shortening the time for the filtration process by agitating the particle slurry during filtration, essentially retarding early formation of a filter cake which is believed to slow down the passage of water. However, such filtration unit requires higher capital expenditure, more complex setup, and additional operation control. For example, a separate power source will be needed to propel the agitation apparatus. Further, even when employing agitation, it would be desirable to be able to further improve filtration times.

### SUMMARY OF THE INVENTION

Filtration processes used to isolate porous particles comprising a continuous polymer phase and internal pores containing an internal aqueous phase from an external aqueous phase has been discovered to be generally very slow. An object of the present invention is accordingly to provide a method for increasing the filtration rates of porous polymer particle dispersions containing water in the pores.

In accordance with one embodiment of the invention, a method of manufacturing porous polymer particles comprises:

forming one or more first water phases comprising an anionic hydrocolloid with a mass-per-charge value of less than 600 and a relatively minor amount, compared to the anionic hydrocolloid, of at least one of a nonionic, cationic, zwitterionic, or weakly anionic water soluble or dispersible polymer, where the weakly anionic water soluble or dispersible polymer has a mass-per-charge value of larger than 600;

forming a water-in-oil emulsion by dispersing the one or more first water phases into an organic phase comprising at least one of either (i) preformed polymer dissolved in an organic solvent or (ii) polymerizable monomers, and homogenizing;

forming a water-in-oil-in-water multiple emulsion by dispersing the water-in-oil emulsion into a second water phase containing a stabilizing agent and homogenizing;

removing the organic solvent to precipitate the preformed polymer or polymerizing the polymerizable monomers to obtain a dispersion of porous polymer particles in an external aqueous phase, wherein individual porous particles each comprise a continuous polymer phase and internal pores containing an internal aqueous phase; and

filtering the dispersion of porous polymer particles with a filter to remove the external aqueous phase.

Optionally, the filtering may be done while the porous polymer particle dispersion is agitated.

### DETAILED DESCRIPTION OF THE INVENTION

As a practical application of porous microparticles, the use of porous toner in the electrophotographic process will reduce the toner mass in the image area. For example toner particles with 50% porosity should require only half as much mass to accomplish the same imaging results. Hence, toner particles having an elevated porosity will lower the cost per page and decrease the stack height of the print as well. The porous particle, and in particular porous toner, technology of the present invention enables a thinner image so as to improve the image quality, reduce curl, reduce image relief, save fusing energy and feel/look more like offset printing rather than typical electrophotographic printing. In addition, colored porous particles will narrow the cost gap between color and monochrome toners. This technology is expected to expand the electrophotographic process to broader application areas and promote more business opportunities for electrophotographic technology.

Porous polymer beads may be used in various applications, such as chromatographic columns, ion exchange and adsorption resins, as drug delivery vehicles, scaffolds for tissue engineering, in cosmetic formulations, and in the paper and paint industries. Methods for generating pores inside polymer particles are known in the field of polymer science. However, due to the specific requirements for toner binder materials, such as suitable glass transition temperatures, cross-linking density and rheology, and sensitivity to particle brittleness that comes from enhanced porosity, the preparation of porous toners is not straightforward. In the present invention, porous particles may be prepared using a multiple emulsion process, in conjunction with a suspension process, particularly, the ELC process. Such process has been found to be suitable in particular for forming porous toner particles with desirable properties.

The porous particles of the present invention include “micro”, “meso”, and “macro” pores which according to the International Union of Pure and Applied Chemistry are the classifications recommended for pores less than 2 nm, 2 to 50 nm, and greater than 50 nm respectively. The term porous particles will be used herein to include pores of all sizes, including open or closed pores.

The preferred process for making the porous particles employed in this invention involves basically a three-step process. The first step involves the formation of a stable water-in-oil (W1/O) emulsion, including a first aqueous solution of a pore stabilizing hydrocolloid dispersed finely in a continuous phase of a preformed binder polymer dissolved in an organic solvent. This first water phase creates the pores in the particles and the pore stabilizing compound controls the pore size and number of pores in the particle, while reinforcing the pores such that the final particle is not brittle or fractured easily.

Suitable pore stabilizing hydrocolloids include both naturally occurring and synthetic, water-soluble or water-swellable polymers such as, cellulose derivatives e.g., carboxymethyl cellulose (CMC) also referred to as sodium carboxymethyl cellulose, gelatin e.g., alkali-treated gelatin such as cattle bone or hide gelatin, or acid treated gelatin such as pigskin gelatin, gelatin derivatives e.g., acetylated gelatin, phthalated gelatin, and the like, substances such as proteins and protein derivatives, synthetic polymeric binders such as poly(vinyl alcohol), poly(vinyl lactams), acrylamide polymers, polyvinyl acetals, polymers of alkyl and sulfoalkyl acrylates and methacrylates, hydrolyzed polyvinyl acetates, polyamides, polyvinyl pyridine, methacrylamide copolymers, water soluble microgels, polyelectrolytes and mixtures thereof.

In order to stabilize the initial first step water-in-oil emulsion so that it can be held without ripening or coalescence, if desired, it is preferable that the hydrocolloid in the water phase have a higher osmotic pressure than that of the binder in the oil phase depending on the solubility of water in the oil. This dramatically reduces the diffusion of water into the oil phase and thus the ripening caused by migration of water between the water droplets. One can achieve a high osmotic pressure in the water phase either by increasing the concentration of the hydrocolloid or by increasing the charge on the hydrocolloid (the counter-ions of the dissociated charges on the hydrocolloid increase the osmotic pressure of the hydrocolloid). Anionic hydrocolloids containing acid groups in the polymer chains are preferably used, which allow for the osmotic pressure of the hydrocolloid phase to be varied for pore size and porosity control.

These anionic hydrocolloids can be characterized by their charge concentration or charge density, which may be quantified by molecular mass-per-charge (m/e) value. Specifically, the m/e values are calculated as the ratio of the polymer molecular mass to the total charge that they carry. For example, polystyrenesulfonate (PSS) has an m/e value of about 209.2. A lower m/e value represents a higher charge density in the polymer or hydrocolloid, which in turn can impart a higher osmotic pressure to the W1 phase with a given weight of hydrocolloid used. Therefore a higher charge density hydrocolloid generally may lead to higher stability of the W1/O emulsion, higher porosity in the porous particle, and allow a wider range of control of the porosity. In general, desired m/e values for the anionic hydrocolloids employed in the present invention are less than 600, preferably less than 500, and more preferably less than 400.

Preferred high charge density hydrocolloids in the present invention are cellulose derivatives, and in particular CMC (Molecular weight 250,000) with degree of substitution (DS, defined as the average number of carboxymethyl groups per anhydroglucose unit in CMC) 0.7, 0.9, or 1.2, with calculated m/e values of 311, 260, and 215, respectively. Other synthetic hydrocolloids include poly(acrylamide acrylic acid) with at least about 25 mole percent acrylic acid monomer (e.g., poly(acrylamide acrylic acid) with 30/70 mole ratio of monomers).

It can also be advantageous to have weak base or weak acid moieties in the pore stabilizing hydrocolloid which allow for the osmotic pressure of the hydrocolloid to be controlled by changing the pH value of its aqueous solution. These hydrocolloids are called “weakly dissociating hydrocolloids” herein. For these weakly dissociating hydrocolloids the osmotic pressure can be increased by buffering the pH to favor dissociation, or by simply adding a base (or acid) to change the pH of the water phase to favor dissociation. A preferred example of such a weakly dissociating anionic hydrocolloid is CMC which has a pH sensitive dissociation (the carboxylate is a weak acid moiety). For CMC the osmotic pressure can be increased by buffering the pH, for example using a pH 6-8 phosphate buffer, or by simply adding a base to raise the pH of the water phase to favor dissociation (for CMC the osmotic pressure increases rapidly as the pH is increased from 4 to 8).

Other synthetic polyelectrolytes hydrocolloids such as polystyrene sulphonate (PSS) or poly(2-acrylamido-2-methylpropanesulfonate) (PAMS) or polyphosphates are also possible anionic hydrocolloids for use in the present invention. These hydrocolloids have strongly dissociating moieties. While the pH control of osmotic pressure which can be advantageous, as described above, is not possible due to the strong dissociation of charges for these strongly dissociating polyelectrolyte hydrocolloids, these systems will be insensitive to varying level of acid impurities. This is a potential advantage for these strongly dissociating polyelectrolyte hydrocolloids particularly when used with binder polymers that have varying levels of acid impurities such as polyesters.

The essential properties of the pore stabilizing hydrocolloids are solubility in water, no negative impact on multiple emulsification process, and no negative impact on melt rheology of the resulting particles when they are used as electrostatographic toners. The pore stabilizing compounds can be optionally cross-linked in the pore to minimize migration of the compound to the surface affecting triboelectrification of the toners. The amount of the hydrocolloid used in the first step will depend on the amount of porosity and size of pores desired and the molecular weight, and charge of the hydrocolloid chosen. A particularly preferred hydrocolloid is CMC and in an amount of from 0.5-20 weight percent of the binder polymer, preferably in an amount of from 1-10 weight percent of the binder polymer.

The first aqueous phase may additionally contain, if desired, salts to buffer the solution and to optionally control the osmotic pressure of the first aqueous phase as described earlier. For CMC the osmotic pressure can be increased by buffering using a pH 7 phosphate buffer. It may also contain additional porogen or pore forming agents such as ammonium carbonate.

For improving the rate of filtration of the resulting porous particles according to one embodiment of the present invention, it is discovered that addition of a second water soluble or dispersible polymeric material in the W1 phase can have a large effect when the first hydrocolloid is anionic.

The second water soluble or dispersible polymer, hereafter referred to as a “filtration aid”, is used in the first aqueous (W1) phase in combination with the main pore stabilizing anionic hydrocolloid. Suitable filtration aids include cationic, non-ionic, zwitterionic or weakly anionic water soluble polymers. When weakly anionic polymers are used, their m/e values are preferably higher than about 600, more preferably higher than about 800.

Filtration aids comprising nonionic, cationic, zwitterionic, or weakly anionic water soluble or dispersible polymers for use in the present invention may comprise, e.g., water soluble polymers such as polyacrylamides (e.g., poly(N-isopropylacrylamide)), cellulose derivatives (e.g., hydroxyethylcellulose), polysaccharides (e.g., dextran), and poly(acrylamide acrylic acid) having less than 25 mole percent acrylic acid monomer (e.g., poly(acrylamide acrylic acid) with 90/10 mole ratio of monomers), and water soluble or dispersible nanogels. The term nanogel refers to a swollen, contiguous, crosslinked polymer network in the size range of from about 5-1000 nanometers through which a through-bond path can be traced between any two atoms (not including counterions). Nanogels useful in the present invention include those described, e.g., in US Pat. App. Pub. No. 2007/0237821, the disclosure of which is incorporated by reference herein in its entirety. Such nanogels may comprise, e.g., a water-compatible, swollen, branched polymer network of repetitive, crosslinked, ethylenically unsaturated monomers of the formula (X)ₘ—(Y)ₙ—(Z)ₒ, wherein X is one or more water-soluble monomers containing ionic or hydrogen bonding moieties, Y is a water-soluble macromonomer containing repetitive hydrophilic units bound to a polymerizeable ethylenically unsaturated group, Z is a multifunctional crosslinking monomer, m may be, e.g., from 50-90 mol %, n may be, e.g., 2-30 mol %, and o may be, e.g., 1-15 mol %. Specifically, Y may be a monomer containing a poly(ethylene glycol) unit, and Z may be a N,N′-methylenebis(acrylamide) compound.

Numerous hydrophilic nanogels are known in the literature and many of those may be used in the present invention as filtration aid. These include hydrophilic colloidal networks in the size range of about 10 to 1000 nm, such as those described by Serguei V. Vinogradov (in Structure and Functional Properties of Colloidal Systems; ed. Roque Hidalgo-Alvarez; CRC Press; Boca Raton, Fla.: 2010; pp 367-386). These include biocompatible or biodegradable polymers containing, e.g., poly(ethylene glycol) or polylactide fragments; stimuli-responsive nanogel materials, such as those comprising poly(N-isopropylacrylamide) or polyethyleneimine groups. Other water soluble polymer fragments may be used, e.g., containing polyalkylene glycols, polyvinyl alcohol (PVA), poly(N-vinylpyrrolidone) (PVP), and polyacrylamides blocks. Copolymer architecture, in addition to the frequently observed linear structures of di-block, tri-block or multiblock, non-linear architectures such as graft or comb, hyperbranch and star or multi-arm may be employed as well.

In addition to the homogeneous solution polymerization method used for the preparation of nanogels as in US Pat. App. Pub. No. 2007/0237821 cited above, other synthetic routes to nanogels are disclosed in the literature such as those reviewed by Alexander V. Kabanov and Serguei V. Vinogradov (Angew Chem Int Ed Engl. 2009; 48(30): 5418-5429; Nanogels as Pharmaceutical Carriers: Finite Networks of Infinite Capabilities). These include chemical synthesis of nanogels by copolymerization in colloidal environments such as W/O or O/W emulsions stabilized with surfactants, physical self-assembly of nanogels in aqueous media, synthesis of nanogels by cross-linking of preformed polymer chains or self-assembled polymeric aggregates like micelles, and template-assisted fabrication of nanogel particles obtained with polymerization reactions.

In the practice of the present invention, the filtration aid is used in the W1 phase in the amount of about 0.1 to about 5 weight percent with respect to the polymer binder. The weight ratio of anionic hydrocolloid with a mass-per-charge value of less than 600 to nonionic, cationic, zwitterionic, or weakly anionic water soluble or dispersible polymer employed as a filtration aid is preferably from 2:1 to 100:1, more preferably from 4:1 to 50:1.

As indicated above, the present invention is applicable to the preparation of polymeric particles from any type of binder polymer or binder resin that is capable of being dissolved in a solvent that is immiscible with water wherein the binder itself is substantially insoluble in water. Useful binder polymers include those derived from vinyl monomers, such as styrene monomers, and condensation monomers such as esters and mixtures thereof. As the binder polymer, known binder resins are useable. Concretely, these binder resins include homopolymers and copolymers such as polyesters, styrenes, e.g. styrene and chlorostyrene; monoolefins, e.g. ethylene, propylene, butylene, and isoprene; vinyl esters, e.g. vinyl acetate, vinyl propionate, vinyl benzoate, and vinyl butyrate; α-methylene aliphatic monocarboxylic acid esters, e.g. methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate; vinyl ethers, e.g. vinyl methyl ether, vinyl ethyl ether, and vinyl butyl ether; and vinyl ketones, e.g. vinyl methyl ketone, vinyl hexyl ketone, and vinyl isopropenyl ketone. Particularly desirable binder polymers/resins include polystyrene resin, polyester resin, styrene/alkyl acrylate copolymers, styrene/alkyl methacrylate copolymers, styrene/acrylonitrile copolymer, styrene/butadiene copolymer, styrene/maleic anhydride copolymer, polyethylene resin and polypropylene resin. They further include polyurethane resin, epoxy resin, silicone resin, polyamide resin, modified rosin, paraffins, and waxes. Also, especially useful are polyesters of aromatic or aliphatic dicarboxylic acids with one or more aliphatic diols, such as polyesters of isophthalic or terephthalic or fumaric acid with diols such as ethylene glycol, cyclohexane dimethanol and bisphenol adducts of ethylene or propylene oxides. Preferably the acid values (expressed as milligrams of potassium hydroxide per gram of resin) of the polyester resins are in the range of 2-100. The polyesters may be saturated or unsaturated. Of these resins, styrene/acryl and polyester resins are particularly preferable.

In the practice of this invention, it is particularly advantageous to utilize resins having a viscosity in the range of 1 to 100 centipoise when measured as a 20 weight percent solution in ethyl acetate at 25° C.

Any suitable solvent that will dissolve the binder polymer and which is also immiscible with water may be used in the practice of this invention such as for example, chloromethane, dichloromethane, ethyl acetate, vinyl chloride, trichloromethane, carbon tetrachloride, ethylene chloride, trichloroethane, toluene, xylene, cyclohexanone, 2-nitropropane and the like. A particularly useful solvent in the practice of this invention are ethyl acetate and propyl acetate for the reason that they are both good solvents for many polymers while at the same time being sparingly soluble in water. Further, their volatility is such that they are readily removed from the discontinuous phase droplets as described below, by evaporation.

Optionally, the solvent that will dissolve the binder polymer and which is immiscible with water may be a mixture of two or more water-immiscible solvents chosen from the list given above. Optionally the solvent may comprise a mixture of one or more of the above solvents and a water-immiscible nonsolvent for the binder polymer such as heptane, cyclohexane, diethylether and the like, that is added in a proportion that is insufficient to precipitate the binder polymer prior to drying and isolation.

When applying the present invention to the preparation of porous electrostatographic toners, various additives generally present in toners may be added to the binder polymer prior to dissolution in the solvent, during dissolution, or after the dissolution step itself, such as colorants, charge control agents, and release agents such as waxes and lubricants. Alternatively, additives may be incorporated into the W1 phase as described in US2010/0021838, the disclosure of which is incorporated by reference herein in its entirety.

Colorants, a pigment or dye, suitable for use in the practice of the present invention are disclosed, for example, in U.S. Reissue Pat. No. 31,072 and in U.S. Pat. Nos. 4,160,644; 4,416,965; 4,414,152 and 4,229,513. As the colorants, known colorants can be used. The colorants include, for example, carbon black, Aniline Blue, Calcoil Blue, Chrome Yellow, Ultramarine Blue, Du Pont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 97, C.I. Pigment Yellow 12, C.I. Pigment Yellow 17, C.I. Pigment Blue 15:1 and C.I. Pigment Blue 15:3. Colorants can generally be employed in the range of from about 1 to about 90 weight percent on a total toner powder weight basis, and preferably in the range of about 2 to about 20 weight percent, and most preferably from 4 to 15 weight percent in the practice of this invention. When the colorant content is 4% or more by weight, a sufficient coloring power can be obtained, and when it is 15% or less by weight, good transparency can be obtained. Mixtures of colorants can also be used. Colorants in any form such as dry powder, its aqueous or oil dispersions or wet cake can be used in the present invention. Colorant milled by any methods like media-mill or ball-mill can be used as well. The colorant may be incorporated in the oil phase or in the first aqueous phase.

The release agents preferably used herein are waxes. Concretely, the releasing agents usable herein are low-molecular weight polyolefins such as polyethylene, polypropylene and polybutene; silicone resins which can be softened by heating; fatty acid amides such as oleamide, erucamide, ricinoleamide and stearamide; vegetable waxes such as carnauba wax, rice wax, candelilla wax, Japan wax and jojoba oil; animal waxes such as bees wax; mineral and petroleum waxes such as montan wax, ozocerite, ceresine, paraffin wax, microcrystalline wax and Fischer-Tropsch wax; and modified products thereof. When a wax containing a wax ester having a high polarity, such as carnauba wax or candelilla wax, is used as the releasing agent, the amount of the wax exposed to the toner particle surface is inclined to be large. On the contrary, when a wax having a low polarity such as polyethylene wax or paraffin wax is used, the amount of the wax exposed to the toner particle surface is inclined to be small. Irrespective of the amount of the wax inclined to be exposed to the toner particle surface, waxes having a melting point in the range of 30 to 150° C. are preferred and those having a melting point in the range of 40 to 140° C. are more preferred. The wax may be, for example, 0.1 to 10% by mass, and more preferably 0.5 to 8% by mass, based on the toner.

The term “charge control” refers to a propensity of a toner addendum to modify the triboelectric charging properties of the resulting toner. A very wide variety of charge control agents for positive charging toners are available. A large, but lesser number of charge control agents for negative charging toners, is also available. Suitable charge control agents are disclosed, for example, in U.S. Pat. Nos. 3,893,935; 4,079,014; 4,323,634; 4,394,430 and British Patents 1,501,065; and 1,420,839. Charge control agents are generally employed in small quantities such as, from about 0.1 to about 5 weight percent based upon the weight of the toner. Additional charge control agents which are useful are described in U.S. Pat. Nos. 4,624,907; 4,814,250; 4,840,864; 4,834,920; 4,683,188 and 4,780,553. Mixtures of charge control agents can also be used.

The second step in the preferred process for formation of the porous particles employed in this invention involves forming a water-in-oil-in-water (W1/O/W2) emulsion by dispersing the above mentioned first water-in-oil emulsion in a second aqueous phase containing either stabilizer polymers such as polyvinylpyrrolidone or polyvinylalcohol or more preferably colloidal silica such as LUDOX™ or NALCOAG™ or latex particles in a modified ELC process such as described in U.S. Pat. Nos. 4,833,060; 4,965,131; 2,934,530; 3,615,972; 2,932,629 and 4,314,932, the disclosures of which are hereby incorporated by reference.

Specifically, in the second step of the preferred process employed in the present invention, the water-in-oil emulsion is mixed with the second aqueous phase containing colloidal silica stabilizer to form an aqueous suspension of droplets that is subjected to shear or extensional mixing or similar flow processes, preferably through an orifice device to reduce the droplet size, yet above the particle size of the first water-in-oil emulsion and achieve narrow size distribution droplets through the limited coalescence process. The pH of the second aqueous phase is generally between 4 and 7 when using silica as the colloidal stabilizer.

The suspension droplets of the first water-in-oil emulsion in the second aqueous phase, results in droplets of binder polymer/resin dissolved in oil containing the first aqueous phase as finer droplets within the bigger binder polymer/resin droplets, which upon drying produces porous domains in the resultant particles of binder polymer/resin. The actual amount of silica used for stabilizing the droplets depends on the size of the final porous particle desired as with a typical limited coalescence process, which in turn depends on the volume and weight ratios of the various phases used for making the multiple emulsion.

Any type of mixing and shearing equipment may be used to perform the first step of preparing a water-in-oil emulsion, such as a batch mixer, planetary mixer, single or multiple screw extruder, dynamic or static mixer, colloid mill, high pressure homogenizer, sonicator, or a combination thereof. While any high shear type agitation device is applicable to this step, a preferred homogenizing device is the MICROFLUIDIZER such as Model No. 110T produced by Microfluidics Manufacturing. In this device, the droplets of the first water phase (discontinuous phase) are dispersed and reduced in size in the oil phase (continuous phase) in a high flow agitation zone and, upon exiting this zone, the particle size of the dispersed oil is reduced to uniform sized dispersed droplets in the continuous phase. The temperature of the process can be modified to achieve the optimum viscosity for emulsification of the droplets and to control evaporation of the solvent. For the second step, where the water-in-oil-in-water emulsion is formed, the shear or extensional mixing or flow process is preferably controlled in order to minimize disruption of the first emulsion. Droplet size reduction may be achieved by homogenizing the emulsion through a capillary orifice device, or other suitable flow geometry. The shear field used to create the droplets in the second emulsion may be created using standard shear geometries, such as an orifice plate or capillary. However, the flow field may also be generated using alternative geometries, such as packed beds of beads, or stacks or screens, which impart an additional extensional component to the flow. It is well known in the literature that membrane based emulsifiers can be used to generate multiple emulsions, the techniques here allow the droplet size to be tailored across a wider range of sizes by adjusting the void volume or mesh size, and may be applied across a wide range of flow rates. In the preferred method employed in this invention, the range of back pressure suitable for producing acceptable particle size and size distribution is between 100 and 5000 psi, more preferably between 500 and 3000 psi. The preferable flow rate is between 1000 and 6000 mL per minute.

The final size of the particle, the final size of the pores and the surface morphology of the particle may be impacted by the osmotic mismatch between the osmotic pressure of the inner water phase, the binder polymer/resin oil phase and the outer water phase. At each interface, the larger the osmotic pressure gradient present, the faster the diffusion rate where water will diffuse from the lower osmotic pressure phase to the higher osmotic pressure phase depending on the solubility and diffusion coefficient in the oil phase. If either the exterior water phase or the interior water phase has an osmotic pressure less than the oil phase then water will diffuse into and saturate the oil phase. For the preferred oil phase solvent of ethyl acetate this can result in approximately 8% by weight water dissolved in the oil phase. If the osmotic pressure of the exterior water phase is higher than the binder phase then the water will migrate out of the pores of the particle and reduce the porosity and particle size. In order to maximize porosity one preferably orders the osmotic pressures so that the osmotic pressure of the outer phase is lowest, while the osmotic pressure of the interior water phase is highest. Thus, the water will diffuse following the osmotic gradient from the external water phase into the oil phase and then into the internal water phase swelling the size of the pores and increasing the porosity and particle size.

If it is desirable to have small pores and maintain the initial small drop size formed in the step one emulsion then the osmotic pressure of both the interior and exterior water phase should be preferably matched, or have a small osmotic pressure gradient. It is also preferable that the osmotic pressure of the exterior and interior water phases be higher than the oil phase. When using weakly dissociating hydrocolloids such as CMC, one can change the pH of the exterior water phase using acid or a buffer preferably a pH 4 citrate buffer. The hydrogen and hydroxide ions diffuse rapidly into the interior water phase and equilibrate the pH with the exterior phase. The drop in pH of the interior water phase containing the CMC thus reduces the osmotic pressure of the CMC. By designing the equilibrated pH correctly one can control the hydrocolloid osmotic pressure and thus the final porosity, size of the pores and particle size.

A way to control the surface morphology as to whether there are open pores (surface craters) or closed pores (a surface shell) is by controlling the osmotic pressure of the two water phases. If the osmotic pressure of the interior water phase is sufficiently low relative to the exterior water phase the pores near the surface may burst to the surface and create an “open pore” surface morphology during drying in the third step of the process.

The third step in the preferred process for preparation of the porous particles employed in this invention involves removal of both the solvent that is used to dissolve the binder polymer and most of the first water phase so as to produce a suspension of uniform porous polymer particles in aqueous solution. The rate, temperature and pressure during drying will also impact the final particle size and surface morphology. Clearly the details of the importance of this process depend on the water solubility and boiling point of the organic phase relative to the temperature of drying process. Solvent removal apparatus such as a rotary evaporator or a flash evaporator may be used in the practice of the method of this invention. The polymer particles may then be isolated, after removing the solvent, by filtration (as further discussed below), followed by drying in an oven at 40° C. which also removes any water remaining in the pores from the first water phase. Optionally, the particles may be treated with alkali to remove the silica stabilizer if used.

Optionally, the third step in the preparation of porous particles described above may be preceded by the addition of additional water, i.e., dilution of W2 phase, prior to removal of the solvent. This step, with the use of anionic hydrocolloids in the W1 phase as the primary pore stabilizer offers a convenient step for greatly increasing the porosity and pore size of the final particles.

Isolation of the porous particles made by the multiple emulsion process generally involves filtration of the particles, typically after contact with base at pH>12, e.g., potassium hydroxide, to remove the colloidal silica stabilizer on the surface of the particles if used, followed by filtration to remove the external water phase and washing until the conductivity of the external water phase is less than 100 micro Seimens/cm, preferably less than 10 micro Seimens/cm. This is followed by another filtration to isolate the particles. Such filtrations have been discovered to be very slow due to the presence of water in the pores, as during filtration hydraulic pressure builds up in the filter cake, especially when the ionic strength in the external water phase is lowered with washing. The problem is magnified during pressure filtration (e.g., wherein greater than atmospheric pressure is applied to the dispersion of porous particles during filtration) or vacuum filtration (e.g., wherein lower than atmospheric pressure is applied on a side of the filter opposite to the dispersion of porous particles during filtration), resulting in very slow filtration. While not wishing to be bound by theory for the slow filtration phenomenon, it is proposed that one possible mechanism by which filtration is slowed is that anionic hydrocolloids increase the charge density on the particle surface, and filtration rate decreases as a result of electrokinetic effect at the surface, which retards the flow of water between the particles. In the practice of the present invention the additional use of cationic, non-ionic, zwitterionic, or only weakly anionic water soluble polymers in the W1 phase may decrease the charge density on the particle surface and thus reduce the electrokinetic effect.

The average particle diameter of the porous particles prepared in accordance with the present invention may be, for example, 2 to 200 micrometers, preferably 2 to 50 micrometers, and more preferably 3 to 20 micrometers. The porosity of the particles is greater than 10%, preferably between 20 and 90% and most preferably between 30 and 70%, where the percent porosity represents the volume of the internal pores as a percentage of the total volume of the particle. Percent porosity may be determined by the methods described in US 2008/0176164 and US 2008/0176157, the disclosures of which are incorporated by reference herein.

In other embodiments, in the process of the present invention, the dispersion of porous polymer particles in an external aqueous phase may be formed where a pore stabilizing anionic hydrocolloid and a filtration aid polymer may be emulsified in an organic phase comprising polymerizable monomers, such as a solution containing a mixture of water-immiscible polymerizable monomers, a polymerization initiator and optionally a colorant and a charge control agent, to form the first water in oil emulsion. The resulting emulsion may then be dispersed in water containing stabilizer as described in the second step of the process to form a water-in-oil-in-water emulsion preferably through the limited coalescence process. The monomers in the emulsified mixture are polymerized in the third step to form droplets of polymer particles, preferably through the application of heat or radiation. Any remaining organic solution may be evaporated, and the resulting suspension polymerized particles may be isolated and dried as described earlier to yield porous particles. In addition, the mixture of water-immiscible polymerizable monomers can contain the binder polymers listed previously.

The shape of toner particles has a bearing on the electrostatic toner transfer and cleaning properties. Thus, for example, the transfer and cleaning efficiency of toner particles have been found to improve as the sphericity of the particles are reduced. A number of procedures to control the shape of toner particles are know in the art. In the practice of this invention, additives may be employed in the second water phase or in the oil phase if necessary. The additives may be added after or prior to forming the water-in-oil-in-water emulsion. In either case the interfacial tension is modified as the solvent is removed resulting in a reduction in sphericity of the particles. U.S. Pat. No. 5,283,151 describes the use of carnauba wax to achieve a reduction in sphericity of the particles. U.S. Pat. No. 7,662,535 B2 describes the use of certain metal carbamates that are useful to control sphericity and U.S. Pat. No. 7,655,375 B2 describes the use of specific salts to control sphericity. US 2007/0298346 describes the use of quaternary ammonium tetraphenylborate salts to control sphericity. The disclosures of these patents and applications are incorporated by reference herein.

Porous toner particles prepared in accordance with embodiments of the present invention may also contain flow aids in the form of surface treatments. Surface treatments are typically in the form of inorganic oxides or polymeric powders with typical particle sizes of 5 nm to 1000 nm. With respect to the surface treatment agent (also known as a spacing agent), the amount of the agent on the toner particles is an amount sufficient to permit the toner particles to be stripped from the carrier particles in a two component system by the electrostatic forces associated with the charged image or by mechanical forces. Preferred amounts of the spacing agent are from about 0.05 to about 10 weight percent, and most preferably from about 0.1 to about 5 weight percent, based on the weight of the toner.

The spacing agent can be applied onto the surfaces of the toner particles by conventional surface treatment techniques such as, but not limited to, conventional powder mixing techniques, such as tumbling the toner particles in the presence of the spacing agent. Preferably, the spacing agent is distributed on the surface of the toner particles. The spacing agent is attached onto the surface of the toner particles and can be attached by electrostatic forces or physical means or both. With mixing, preferably uniform mixing is preferred and achieved by such mixers as a high energy Henschel-type mixer which is sufficient to keep the spacing agent from agglomerating or at least minimizes agglomeration. Furthermore, when the spacing agent is mixed with the toner particles in order to achieve distribution on the surface of the toner particles, the mixture can be sieved to remove any agglomerated spacing agent or agglomerated toner particles. Other means to separate agglomerated particles can also be used for purposes of the present invention.

The preferred spacing agent is silica, such as those commercially available from Degussa, like R-972, or from Wacker, like H2000. Other suitable spacing agents include, but are not limited to, other inorganic oxide particles, polymer particles and the like. Specific examples include, but are not limited to, titania, alumina, zirconia, and other metal oxides; and also polymer particles preferably less than 1 μm in diameter (more preferably about 0.1 μm), such as acrylic polymers, silicone-based polymers, styrenic polymers, fluoropolymers, copolymers thereof, and mixtures thereof.

The invention will further be illustrated by the following examples. They are not intended to be exhaustive of all possible variations of the invention.

The Kao Binder E, a polyester resin, used in the examples below was obtained from Kao Specialties Americas LLC a part of Kao Corporation, Japan. Carboxymethyl cellulose molecular weight approximately 250K as the sodium salt was obtained from Acros Organics. Pigment Blue 15:3 was from Sunchemical and milled in ethyl acetate together with Kao E. The wax used in the preparation of Examples C-1 and I-17 was the ester wax WE-3® from NOF Corporation milled in ethyl acetate using a triblock copolymer, PPC-b-PEB-b-PPC (Mn=8300, PEB=2500, PPC=2900 each), as dispersing aid. NALCOAG™ 1060, a colloidal silica, was obtained from Nalco Company as a 50 weight percent dispersion.

The particle size and distribution were characterized by a Coulter Particle Analyzer. The volume median value from the Coulter measurements was used to represent the particle size of the particles described in these examples.

The extent of porosity of the particles of the present invention can be visualized using a range of microscopy techniques. Conventional Scanning Electron Microscope (SEM) imaging was used to image fractured samples and view the inner pore structure. The SEM images give an indication of the porosity of the particles, but are not normally used for quantification. The level of porosity of the particles of the present invention was measured using a combination of methods. The outside or overall diameter of the particles is easily measured with a number of aforementioned particle measurement techniques, but determining the extent of particle porosity can be problematic. Determining particle porosity using typical gravitational methods can be problematic due to the size and distribution of pores in the particles and whether or not some pores break through to the particle surface. To accurately determine the extent of porosity in the particles of the present invention a combination of conventional diameter sizing and time-of-flight methods was used. The time-of-flight method used to determine the extent of porosity of the particles in the present invention includes the Aerosizer particle measuring system. The Aerosizer measures particle sizes by their time-of-flight in a controlled environment. This time of flight depends critically on the density of the material. If the material measured with the Aerosizer has a lower density due to porosity or a higher density due, for example, to the presence of fillers, then the calculated diameter distribution will be shifted artificially low or high respectively. Independent measurements of the true particle size distribution via alternate methods (e.g. Coulter) can then be used to fit the Aerosizer data with particle density as the adjustable parameter. The method of determining the extent of particle porosity of the particles of the present invention is as follows. The outside diameter particle size distribution is first measured using the Coulter particle measurement system. The mode of the volume diameter distribution is chosen as the value to match with the Aerosizer volume distribution. The same particle distribution is measured with the Aerosizer and the apparent density of the particles is adjusted until the mode (D50%) of the two distributions matches. The ratio of the calculated and solid particle densities is taken to be the extent of porosity of the particles. The porosity values measured using the Aerosizer generally have uncertainties of +/−10%.

Another method of measuring porosity is mercury intrusion porosimetry. This technique typically can estimate the porosity due to internal pores accurately but may not be able to detect surface or open pores. Since the particles obtained by the present multiple emulsion method have little surface pores, mercury intrusion porosimetry is expected to perform well in measuring the porosity of the porous particles.

Nanogels used in the present invention as filtration aids comprise cross linked polymer networks and may be prepared according to the procedures outlined in US Patent Application Publication US 2007/0237821 A1, incorporated in its entirety by reference above. Nanogels prepared according to the above procedure are listed in Table 1 and Table 2. Other water soluble polymers used in the examples are shown in Table 3.

TABLE 1
Non-ionic Nanogels (Mole Composition)

| | % | % | % | |
|---|---|---|---|---|
| | HEMA | MBAm | PEGME-MA | MW of PEGME-MA |
| NG-1 | 69.79 | 14.73 | 15.48 | ~1100 |
| NG-2 | 67.65 | 17.85 | 14.51 | ~1100 |
| NG-3 | 64.75 | 21.16 | 14.09 | ~1100 |
| NG-4 | 56.81 | 14.98 | 28.21 | ~475 |
| NG-5 | 66.72 | 22.53 | 10.75 | ~2080 |

HEMA = 2-Hydroxyethyl methacrylate
MBAm = N,N′-Methylenebis(acrylamide)
PEGME-MA = Poly(ethylene glycol) methyl ether methacrylate

TABLE 2
Ionic Nanogels (Mole Composition)

| | % | % | % | % | Mass per |
|---|---|---|---|---|---|
| | HEMA | MBAm | PEGME-MA | Ionics | (−)Charge |
| NG-6 | 43.49 | 19.32 | 16.52 | 20.68 CEA | 1429 |
| NG-7 | 44.25 | 19.66 | 16.81 | 19.28 Zm | Cationic |
| NG-8 | 30.21 | 18.21 | 14.30 | 18.64 CEA | Zwitterionic |
| | | | | 18.64 Zm | |
| NG-9 | 46.28 | 20.56 | 16.14 | 17.02 Ds | Zwitterionic |

HEMA = 2-Hydroxyethyl methacrylate
MBAm = N,N′-Methylenebis(acrylamide)
PEGME-MA = Poly(ethylene glycol) methyl ether methacrylate (MW ~1100)
CEA = 2-Carboxyethyl acrylate
Zm = DMAE-MA = 2-Dimethylaminoethyl methacrylate
Ds = 2-Methacryloyloxyethyldimethyl-3-sulfopropylammonium hydroxide

TABLE 3
Other Water Soluble Polymers

| | | Mass per |
|---|---|---|
| | Compound | (−)Charge |
| WSP-1 | Poly(N-isopropylacrylamide); (Aldrich) | NA |
| WSP-2 | Hydroxylethylcellulose (High Viscosity; Fluka) | NA |
| WSP-3 | Dextran (MW 100K; Fluka) | NA |
| WSP-4 | Poly(acrylamide acrylic acid) (90:10) | 734 |
| | (MW 200K; Polysciences) | |
| WSP-5 | Poly(acrylamide acrylic acid) (30:70) | 125 |
| | (MW 200K; Polysciences) | |
| WSP-6 | Carboxymethylcellulose | 260 |
| | (MW 250K, DS 0.9; Sigma-Aldrich) | |

### Preparation of Porous Particles

### Comparative Example 1 (C-1)

CMC molecular weight 250K (DS 0.7) was dissolved in distilled water to make a 3.25 weight percent solution. An appropriate amount (46.92 g) of this concentrated solution was diluted with water to make a total 76.92 g of W1 phase with CMC at a concentration of 1.98 weight percent. The W1 phase was dispersed in an oil phase containing 49.25 g of Kao E and 0.75 g of FCA-2508N and 200.0 g of ethyl acetate and stirred for two minutes at 6800 RPM using a Silverson L4R homogenizer fitted with the General-Purpose Disintegrating Head. The resultant water-in-oil emulsion was further homogenized using a Microfluidizer Model #110T from Microfluidics at a pressure of about 8500 psi. A 250 g aliquot of the resultant very fine water-in-oil emulsion was dispersed into 416.7 grams of a second water phase comprising a pH 4 buffer and about 22.6 grams of NALCOAG™ 1060, using the Silverson homogenizer which was equipped with a large hole disintegration head for two minutes at 2000 RPM. The mixture was further homogenized in an orifice homogenizer at 1000 psi to form a water-in-oil-in-water double emulsion. A 500 g aliquot of the double emulsion was first mixed with 500 g of water and the ethyl acetate solvent was evaporated using a Buchi Rotovapor RE120 at 40° C. under reduced pressure to form a dispersion of porous polymer particles. The suspension was allowed to settle and the supernatant decanted, and the entire residue was used for filtration studies.

### Filtration Experiments

The wet particle residue from above was combined with 1200 g of water and the pH value raised to about 12.5 with 1 N KOH solution. After stirring for about 30 min, the suspension is transferred to a pressure filtration unit, which is composed of a stainless steel vessel fitted with a Polypropylene Multi/Texturized (78×20) Oxford weave filter cloth of 12.0 cm in diameter. An air pressure of 16 psi was applied to the filtration unit and the time for the aqueous fluid to completely pass the filter cloth was recorded. The filter cake was washed with 1200-g aliquots of fresh deionized water under the same pressure, and filtration time for each wash similarly recorded. After three washes the conductivity of the filtrate was generally less than about 6 μS/cm. The cake was then air dried followed by drying in a vacuum oven at 40° C. for 24 h. The dry powder was weighed, and the particle size, particle shape, and particle porosity measured using appropriate techniques as stated above.

### Comparative Example 2 (C-2)

The same procedure as in Comparative Example 1 was used except that the first aqueous phase also contained 0.305 weight percent of poly(acrylamide acrylic acid) (30/70 mole ratio).

### Comparative Example 3 (C-3)

The same procedure as in Comparative Example 1 was used except that the first aqueous phase contained 1.85 weight percent CMC (MW 250K, DS 0.7) and 0.305 weight percent of CMC (MW 250K, DS 0.9).

### Comparative Example 4 (C-4)

In this Example, porous cyan porous toner particles were prepared with the same method as in C-1, except that the first aqueous phase was 2.01 weight percent CMC (MW 250K, DS 0.7) and the oil phase consisted of 40.65 of Kao E, 4.00 g of Pigment Blue 15:3, 4.00 g of WE-3 in the form of a solid particle dispersion describe above, and 0.75 g of FCA-2508N in a total of 200.0 g of ethyl acetate solvent.

### Comparative Example 5 (C-5)

In this Example, NG-3 was used after the double emulsion was formed, so that following the same procedure as in C-1, NG-3, at the same level as in 1-5 below, was added to the 500 g of water that was used to mix with the double emulsion before solvent removal by evaporation on a rotary evaporator. The resulting particles have volume median diameter of 6.994 porosity of 41.4%, and somewhat non-spherical shape. The filtration rate was 10.8 min for the initial passage of the basic water phase, and over at least 85 min for the first wash.

The filtration process for C-5 apparently became much slower than that for C-1 sample, indicating that NG-3 need to be incorporated in W1 phase to facilitate filtration.

### Inventive Examples 1 through 11 (I-1 through I-11)

Inventive samples (I-1 through I-11) for filtration evaluation were prepared by the same procedure as in C-1, except that the W1 phase was prepared using appropriate amounts of the 3.25 weight percent solution of CMC together with various amounts of water soluble polymeric filtration aid solutions in water to arrive at the levels in W1 phase (as weight percent concentration) as listed in Table 4. In general, the CMC concentration in W1 phase was kept about constant with minor adjustments to compensate for the effect of the water soluble polymeric filtration aid on the porosity of the final particle.

### Inventive Examples 12 (I-12)

This example uses a mixture of NG-6 (anionic nanogel) and NG-7 (cationic nanogel) in 1:1 mole ratio in the W1 phase as filtration aid. The same method as in I-1 to I-11 was used.

In comparison with I-11 where a zwitterionic nanogel was used, the use of the mixed separate nanogels in W1 is slightly less efficient at increase filtration rate. Compared with C-1, however, the I-12 particles have a much faster filtration rate.

### Inventive Examples 13 through 16 (I-13 through I-16)

Other water soluble polymers (WSP-1 through WSP-4), generally of high molecular weight, were used in W1 phase according to the same method of I1-I11 to prepare the samples of I-13 through I-16.

### Inventive Examples 17 (I-17)

In this Example, porous cyan porous toner particles were prepared with the same method as in C-4, except that the first aqueous phase contained 2.00 weight percent CMC (MW 250K, DS 0.7) and 0.305 weight percent of NG-2.

In comparison with C-4, as shown in Table 6, the filtration rate of I-17 is much improved by the simple incorporation of the low level of NG-2 in the W1 during preparation of the particles.

It can be seen from the examples in Tables 4 through 6 that incorporation of only low levels of the filtration aiding polymers in the first water phase leads to large increases in filtration rate of the porous particles, which generally have very similar particle sizes and porosities. I-15 which was prepared with the use of Dextran had small particles but still acceptable filtration rate. It can also be seen that non-ionic, cationic, and zwitterionic water soluble high molecular weight polymers when incorporated in the first aqueous phase at low levels can increase the filtration rate, while highly anionic ones like poly(acrylamide acrylic acid), sodium salt with 70% carboxylate, may further decrease the filtration rate.

TABLE 4
Examples Using Synthesized Nanogels

| | | | | Vol Median | | Filtration time, min | | | |
|---|---|---|---|---|---|---|---|---|---|
| | CMC in | W1 | Level in | Diameter | | | 1st | 2nd | 3rd |
| Ex. | W1 | Addenda | W1 | (microns) | Porosity | Initial | Wash | Wash | Wash |
| C-1 | 1.98% | — | — | 6.99 | 40.7% | 3.0 | 39.5 | 59.0 | 58.0 |
| I-1 | 2.00% | NG-1 | 0.236% | 6.81 | 33.9% | 3.13 | 13.95 | 26.83 | 24.53 |
| I-2 | 2.00% | NG-2 | 0.30% | 7.07 | 39.0% | 2.52 | 11.13 | 14.85 | 16.97 |
| I-3 | 1.97% | NG-3 | 0.33% | 6.84 | 19.5% | 2.68 | 6.33 | 10.27 | 11.92 |
| I-4 | 1.95% | NG-3 | 1.36% | 7.20 | 45.6% | 2.88 | 6.18 | 8.12 | 10.17 |
| I-5 | 1.97% | NG-3 | 0.67% | 7.53 | 43.0% | 2.77 | 8.93 | 12.83 | 17.55 |
| I-6 | 2.02% | NG-3 | 0.09% | 6.90 | 40.4% | 2.42 | 12.77 | 20.82 | 26.33 |
| I-7 | 2.00% | NG-4 | 0.305% | 7.09 | 34.8% | 2.50 | 9.43 | 20.08 | 23.33 |
| I-8 | 2.00% | NG-5 | 0.305% | 7.53 | 35.2% | 2.68 | 9.58 | 23.00 | 24.58 |
| I-9 | 2.00% | NG-6 | 0.305% | 6.91 | 35.1% | 2.65 | 11.63 | 23.72 | 21.67 |
| I-10 | 2.00% | NG-7 | 0.305% | 7.66 | 44.3% | 2.62 | 6.83 | 11.87 | 12.33 |
| I-11 | 2.00% | NG-8 | 0.305% | 7.00 | 45.1% | 2.52 | 4.93 | 9.18 | 9.15 |
| I-12 | 2.00% | NG-6/NG-7 | 0.305% | 7.33 | 45.0% | 2.40 | 6.73 | 13.47 | 12.45 |
| | | | total | | | | | | |

TABLE 5
Examples Using Water Soluble Polymers

| | | | | Vol Median | | Filtration time, min | | | |
|---|---|---|---|---|---|---|---|---|---|
| | CMC in | W1 | Level in | Diameter | | | 1st | 2nd | 3rd |
| Ex. | W1 | Addenda | W1 | (microns) | Porosity | Initial | Wash | Wash | Wash |
| C-2 | 1.90% | WSP-5 | 0.305% | 7.22 | 44.0% | 4.6 | 152.7 | 187.6 | 170.9 |
| C-3 | 1.85% | WSP-6 | 0.305% | N/A | 33.2% | 3.1 | 42.8 | 79.0 | 67.6 |
| I-13 | 1.99% | WSP-1 | 0.305% | 6.27 | 48.5% | 3.58 | 12.07 | 22.57 | 22.51 |
| I-14 | 1.95% | WSP-2 | 0.305% | 6.91 | 38.0% | 2.63 | 7.23 | 14.03 | 19.00 |
| I-15 | 2.00% | WSP-3 | 0.305% | 4.78 | 40.5% | 3.18 | 18.85 | 39.75 | 36.88 |
| I-16 | 1.95% | WSP-4 | 0.305% | 7.06 | 38.8% | 3.02 | 24.22 | 41.28 | 37.55 |

TABLE 6
Cyan Colored Samples

| | | | | Vol Median | | Filtration time, min | | | |
|---|---|---|---|---|---|---|---|---|---|
| | CMC in | W1 | Level in | Diameter | | | 1st | 2nd | 3rd |
| Ex. | W1 | Addenda | W1 | (microns) | Porosity | Initial | Wash | Wash | Wash |
| C-4 | 2.01% | — | — | 6.96 | 45.5% | 4.9 | 101.1 | 127.7 | 120.0 |
| I-17 | 2.00% | NG-2 | 0.305% | 7.61 | 48.6% | 3.47 | 24.37 | 32.28 | 35.40 |

The invention has been described in detail with particular reference to certain preferred embodiments thereof, but it will be understood that variations and modifications can be effected within the spirit and scope of the invention.

1. A method of manufacturing porous polymer particles comprising:
forming one or more first water phases comprising an anionic hydrocolloid with a mass-per-charge value of less than 600 and a relatively minor amount, compared to the anionic hydrocolloid, of at least one of a nonionic, cationic, zwitterionic, or weakly anionic water soluble or dispersible polymer, where the weakly anionic water soluble or dispersible polymer has a mass-per-charge value of larger than 600;
forming a water-in-oil emulsion by dispersing the one or more first water phases into an organic phase comprising at least one of either (i) preformed polymer dissolved in an organic solvent or (ii) polymerizable monomers, and homogenizing;
forming a water-in-oil-in-water multiple emulsion by dispersing the water-in-oil emulsion into a second water phase containing a stabilizing agent and homogenizing;
removing the organic solvent to precipitate the preformed polymer or polymerizing the polymerizable monomers to obtain a dispersion of porous polymer particles in an external aqueous phase, wherein individual porous particles each comprise a continuous polymer phase and internal pores containing an internal aqueous phase; and
filtering the dispersion of porous polymer particles with a filter to remove the external aqueous phase.

2. The method of claim 1, wherein greater than atmospheric pressure is applied to the dispersion of porous polymer particles during filtration, or lower than atmospheric pressure is applied on a side of the filter opposite to the dispersion of porous polymer particles during filtration.

3. The method of claim 1, wherein the external aqueous phase of the dispersion of porous polymer particles has a specific conductivity of less than 100 micro Seimens/cm.

4. The method of claim 1 further comprising drying the filtered porous polymer particles to remove the internal aqueous phase from the internal pores.

5. The method of claim 1, wherein the anionic hydrocolloid with a mass-per-charge value of less than 600 is selected from the group consisting of carboxymethyl cellulose (CMC), polystyrene sulphonate, poly(2-acrylamido-2-methylpropanesulfonate), and polyphosphates.

6. The method of claim 1, wherein the anionic hydrocolloid with a mass-per-charge value of less than 600 comprises a cellulose derivative.

7. The method of claim 1, wherein the anionic hydrocolloid with a mass-per-charge value of less than 600 comprises carboxymethyl cellulose (CMC).

8. The method of claim 1, wherein the anionic hydrocolloid has a mass-per-charge value of less than 500.

9. The method of claim 1, wherein the anionic hydrocolloid has a mass-per-charge value of less than 400.

10. The method of claim 1, wherein the nonionic, cationic, zwitterionic, or weakly anionic water soluble or dispersible polymer comprises a nanogel.

11. The method of claim 1, wherein the weight ratio of anionic hydrocolloid with a mass-per-charge value of less than 600 to nonionic, cationic, zwitterionic, or weakly anionic water soluble or dispersible polymer is from 2:1 to 100:1.

12. The method of claim 1, wherein the weight ratio of anionic hydrocolloid with a mass-per-charge value of less than 600 to nonionic, cationic, zwitterionic, or weakly anionic water soluble or dispersible polymer is from 4:1 to 50:1.

13. The method of claim 1, wherein the stabilizing agent comprises colloidal silica or latex particles.

14. The method of claim 1, wherein the porous polymer particles comprise toner particles.

15. The method of claim 14, wherein the water-in-oil emulsion further comprises a colorant.

16. The method of claim 14, wherein the water-in-oil emulsion further comprises a charge control agent.

17. The method of claim 14, wherein the water-in-oil emulsion further comprises a colorant and a wax.

18. The method of claim 1, wherein the water-in-oil emulsion is formed by dispersing the one or more first water phases into an organic phase comprising preformed polymer dissolved in an organic solvent, and the organic solvent is removed from the water-in-oil-in-water emulsion by evaporation to precipitate the preformed polymer and obtain a dispersion of porous polymer particles in an external aqueous phase.

19. The method of claim 18, wherein the preformed polymer is formed from vinyl monomers, condensation monomers, condensation esters, or mixtures thereof.

20. The method of claim 18, wherein the preformed polymer comprises a polyester.

21. The method of claim 18, wherein the organic solvent comprises ethyl acetate, propyl acetate, chloromethane, dichloromethane, vinyl chloride, trichloromethane, carbon tetrachloride, ethylene chloride, trichloroethane, toluene, xylene, cyclohexanone, or 2-nitropropane.

22. The method of claim 1, wherein the water-in-oil emulsion is formed by dispersing the one or more first water phases into an organic phase comprising polymerizable monomers, and the polymerizable monomers are polymerized in the water-in-oil-in-water emulsion to form droplets of polymer particles and obtain a dispersion of porous polymer particles in an external aqueous phase.

23. The method of claim 1, wherein formed porous polymer particles have a porosity of 30-70%.
